(19) United States
(12) Patent Application Publication
(10) Pub. No.: US 2024/0143666 A1
(43) Pub. Date: May 2, 2024

(54) SMART METRIC CLUSTERING

(71) Applicant: Microsoft Technology Licensing, LLC, Redmond, WA (US)

(72) Inventors: Hagit GRUSHKA, Beer-Sheva (IL); Jeremy SAMAMA, Netanya (IL); Michael ALBURQUERQUE, Tel Aviv (IL); Eliya HABBA, Jerusalem (IL); Rachel LEMBERG, Herzliya (IL); Yaniv LAVI, Tel Aviv (IL)

(73) Assignee: Microsoft Technology Licensing, LLC, Redmond, WA (US)

(21) Appl. No.: 18/325,433

(22) Filed: May 30, 2023

Related U.S. Application Data
(60) Provisional application No. 63/381,700, filed on Oct. 31, 2022.

(51) Int. Cl. G06F 16/906; G06F 16/907

(52) U.S. Cl. CPC G06F 16/906; G06F 16/907

(57) ABSTRACT

Systems and methods for clustering metrics for reducing a search space of metrics used for service health analyses. Determining a root cause of an event includes performing an automated analysis of metrics associated with the service. To diagnose and resolve events quickly and efficiently, aspects correlate and cluster a plurality of metrics for a specific service based on historical data, where each cluster represents a root cause direction. After clustering metrics by similarity, metrics are scored and ranked to select representative metrics from each cluster, which reduces the dimensionality of the search space. The representative metrics may provide a saliant representation of each metrics cluster. The representative metrics are provided to a service health analyzer, which performs a root cause analysis of the representative metrics to diagnose and mitigate the event.

### CROSS-REFERENCE TO RELATED APPLICATIONS

This application claims the benefit of U.S. Provisional Patent Application No. 63/381,700, titled “SMART METRIC CLUSTERING,” filed Oct. 31, 2022, which is incorporated by reference herein in its entirety.

### BACKGROUND

Service owners in cloud computing often define thousands of metrics for monitoring the health of their services. For instance, various data are continually collected and checked for monitoring a service's performance. In some examples, when a monitored metric falls outside a threshold level, a service event is detected. A service event, for example, is associated with a service performance issue, outage, or other unavailability. A service health analyzer is oftentimes used to analyze a service event when one occurs. In some examples, the service health analyzer diagnoses and provides technical support for service events. In some examples, the service health analyzer generates an incident report to provide information about a service event, such as the root cause of the service event. In some examples, when such a service event is detected, metrics are analyzed to diagnose and mitigate the root cause of the event. For instance, root cause analyses are not only useful to the service environment but are additionally useful to customers and the industry at large who can learn from retrospectives on service events to understand steps that the service environment may take to make such events less likely and/or less impactful in the future. Manual root cause analysis of thousands of metrics is very difficult. Automated analysis of such a volume of metrics is computationally expensive and can be slow to perform. Being able to determine and mitigate the root cause of the event quickly and efficiently reduces the impact the event may have on customer applications and services.

It is with respect to these and other considerations that examples have been made. In addition, although relatively specific problems have been discussed, it should be understood that the examples should not be limited to solving the specific problems identified in the background.

### SUMMARY

Examples described in this disclosure relate to systems and methods for clustering metrics for reducing dimensionality of a search space of metrics used for health analyses of a service or of an application built on a service. A service refers to software functionality that provides (e.g., performs or enables access to) one or more capabilities. An application built on a service refers to an application (or service) that leverages the capabilities of one or more underlying services as building blocks to provide an enhanced, more feature-rich set of software functionality. Determining a root cause of an event includes performing an automated analysis of metrics associated with the service event, which typically includes thousands of metrics (or more). To diagnose and resolve events quickly and efficiently, aspects of the present disclosure receive, correlate, and cluster a plurality of metrics corresponding to a service event for a service based on historical data, where each cluster represents a root cause direction. Metrics are then scored and ranked in each cluster to select representative metrics from each cluster, which reduces the dimensionality of the search space. According to examples, each cluster represents a metric correlation; therefore, one or more representative metrics from each cluster are selected, rather than using the full set the metrics for root cause analysis. Accordingly, a list of representative metrics is determined, where the list has a lower dimensionality than the plurality of received metrics corresponding to the service event and provides a saliant representation of each metric cluster. The representative metrics are provided to a service health analyzer, which performs a root cause analysis of the representative metrics to diagnose and mitigate the service event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of a system in which service metrics clustering is implemented according to an example;

FIG. 2 is a block diagram of a data flow for providing service metrics clustering according to an example;

FIG. 3 is a flowchart depicting operations of a method for providing service metrics clustering according to an example;

FIG. 4 is a flowchart depicting operations of a method for providing service metrics clustering according to another example; and

FIG. 5 is a block diagram illustrating example physical components of a computing device with which aspects of the disclosure may be practiced.

### DETAILED DESCRIPTION

Examples described in this disclosure relate to systems and methods for providing service health metrics clustering. Service health analyses involve analyzing vast amounts of various metrics. A root cause analysis includes evaluating data sets of metric data to determine an underlying cause of a service event. A service event, sometimes referred to as a service performance issue, is a degradation in performance of a service by a quantifiable amount. For instance, traditional approaches of gathering and analyzing metrics for a root cause analysis of a service event, can often resemble “searching for a needle in a haystack.” Such traditional approaches are computationally expensive (e.g., use a large amount of computer processing resources, memory, and processing time) to diagnose the root cause of the event, where quick detection and mitigation of the service event reduces the impact the event may have on dependent applications and services. Thus, aspects of the present disclosure describe systems and methods that cluster and score metrics for reducing a search space of metrics used for service health analyses.

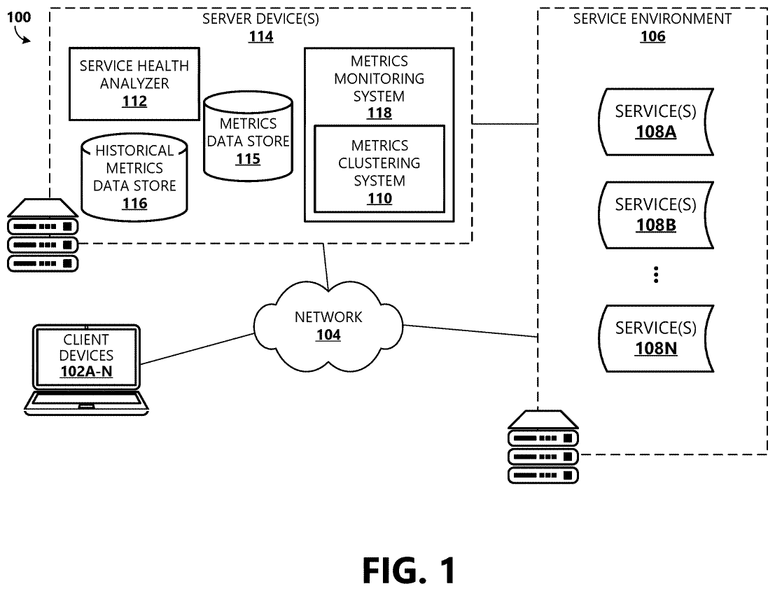

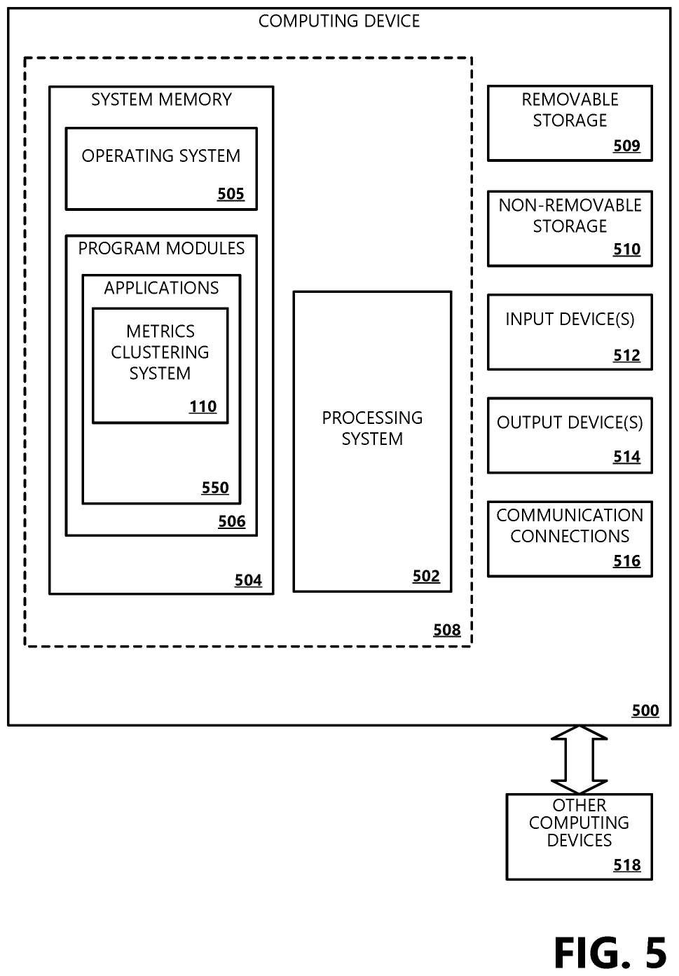

FIG. 1 is a block diagram of an example system 100 for service health metrics clustering. The example system 100 as depicted is a combination of interdependent components that interact to form an integrated whole. Components of the system 100 are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. In another example, the components of systems disclosed herein are distributed across multiple processing devices. For instance, input may be entered on a user device or client device and information may be processed on or accessed from other devices in a network, such as one or more remote cloud devices or web server devices. The processing device(s) may provide an operating environment for software components to execute and utilize resources or facilities of such a system. An example of processing device(s) comprising such an operating environment is depicted in FIG. 5.

In FIG. 1, the system 100 includes client devices 102a-n (collectively “client device(s) 102”), a network 104, a service environment 106 including one or more service(s) 108a-n (collectively “service(s) 108”), and one or more server device(s) 114 on which a metrics clustering system 110, a service health analyzer 112, a metrics data store 115, and a historical metrics data store 116 operate. The scale and structure of systems such as system 100 may vary and may include additional or fewer components than those described in FIG. 1. As one example, the service environment 106, and/or one or more service(s) 108 are incorporated into a client device(s) 102 or the server device 114. As another example, the service health analyzer 112, the metrics clustering system 110, the metrics data store 115, and/or the historical metrics data store 116 operate in the service environment 106.

The client device(s) 102 detect and/or collect input data from one or more users or user devices. In some examples, the input data corresponds to user interaction with one or more software applications or services implemented by, or accessible to, the client device(s) 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of user activity corresponding to a task, a project, a data request, or the like. The input data may include, for example, audio input, touch input, text-based input, gesture input, and/or image input. The input data is detected/collected using one or more sensor components of client device(s) 102. Examples of sensors include microphones, touch-based sensors, geolocation sensors, accelerometers, optical/magnetic sensors, gyroscopes, keyboards, and pointing/selection tools. Examples of client device(s) 102 include personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices, and Internet of Things (IoT) devices.

In various implementations, the client device(s) 102 provide the input data to the service environment 106. In some examples, the input data is provided to the service environment 106 using the network 104. Examples of the network 104 include one or a combination of a private area network (PAN), a local area network (LAN), a wide area network (WAN), and the like. Although the network 104 is depicted as a single network, it is contemplated that network 104 may represent several networks of similar or varying types. In some examples, the input data is provided to the service environment 106 without using the network 104.

The service environment 106 provides the client device(s) 102 access to various computing resources (e.g., services, applications, devices, storage, processing power, networking, analytics, intelligence). In some examples, the service environment 106 is implemented in a cloud-based or server-based environment using one or more computing devices, such as server devices (e.g., web servers, file servers, application servers, database servers), edge computing devices (e.g., routers, switches, firewalls, multiplexers), personal computers (PCs), virtual devices, and mobile devices. In other examples, the service environment 106 is implemented in an on-premises environment (e.g., a home or an office) using such computing devices. In some implementations, the service environment 106 includes numerous hardware and/or software components and is subject to one or more distributed computing models/services (e.g., Infrastructure as a Service (IaaS), Platform as a Service (PaaS), Software as a Service (SaaS), Functions as a Service (FaaS)). In aspects, the service environment 106 includes or provides access to various service(s) 108.

In some examples, service(s) 108 are integrated into (e.g., hosted by or installed in) the service environment 106. Alternatively, one or more of service(s) 108 are implemented externally to the service environment 106. For instance, one or more of service(s) 108 may be implemented in a service environment separate from the service environment 106 or in client device(s) 102. In examples, the service(s) 108 provide access to a set of software and/or hardware functionality. Examples of service(s) 108 include virtual meeting services, topic detection and/or classification services, data domain taxonomy services, expertise assessment services, content detection services, audio signal processing services, word processing services, spreadsheet services, presentation services, document-reader services, social media software or platforms, search engine services, media software or platforms, multimedia player services, content design software or tools, database software or tools, provisioning services, and alert or notification services.

In some implementations, the system 100 includes a metrics monitoring system 118 that collects metrics from various metrics sources and stores the metrics in a metrics data store 115. For example, metrics are quantitative measurements of a resource (e.g., a service 108) that is monitored and describe an aspect of the resource at a particular time. For instance, metrics such as response time, throughput, memory usage, central processing unit (CPU) usage, queue time, requests per unit of time, browser exceptions, error types and counts, success rates, input/output (I/O) read and write data, and other metrics are collected, stored, and analyzed for detecting and resolving issues with a service 108. In some examples, metrics are recorded as time-stamped values. For instance, the metrics data store 115 is a time-series database that is optimized for analyzing time-stamped data, where time-series metrics can be analyzed from a time perspective for various analyses, such as for monitoring metrics and for root cause analyses In some examples, properties of the metrics are also stored in the metrics data store 115, such as a time when the metric was collected, the service(s) 108 associated with the metric, a namespace for the metric, a metric name, a metric value, a metric sampling type (e.g., sum, count, and average), and one or more metric dimensions. Metric dimensions are name/value pairs that carry additional data to describe the metric. For example, a metric may be a “CPU usage” metric that tracks a percentage of time a CPU is actively processing instructions. A service 108 may include multiple virtual machines (VMs), where the “CPU usage” metric may have a dimension called “VM” that captures the CPU usage for each VM. By using the “VM” dimension, the “CPU usage” metric can be filtered by VM to identify CPU usage by individual VM or across all VMs. For instance, the “CPU usage” metric and its dimensions can be analyzed to identify a service event or to identify a root cause of a service event.

In some examples, monitoring metrics includes collecting and analyzing metrics on various aspects of a service 108, such as performance, availability, and usage. For instance, metrics provide quantitative measurements of the service's behavior over time. In some examples, the metrics monitoring system 118 monitors various metrics and detects service events that deviate from expected or desired behavior. For example, healthy systems have metrics that are steady, predictable, and exhibit a regular pattern. The metrics monitoring system 118 may detect a service event in association with an increase in response time, a drop in availability, or another unexpected or undesired metric behavior. In some examples, a service event is represented as an anomaly or outlier in various metrics characterizing the service event.

According to examples, the service health analyzer 112 performs one or more health analyses of the service(s) 108 in the service environment 106. In some implementations, the service health analyzer 112 performs root cause analyses of detected service events. For instance, the service events may correspond to a service performance issue, outage, or other service interruption or unavailability detected to have occurred by the metrics monitoring system 118 in association with a service 108. In some examples, the root cause analysis includes collecting a plurality of metrics recorded within a time period during which the service event occurred, analyzing a sequence of behaviors leading up to the detected event, and identifying contributing factors that directly led to the service event or played a role in creating conditions in which the service event manifested. In some examples, the metrics monitoring system 118 further generates an incident report to provide information about the root cause.

In some instances, the plurality of metrics recorded within a time period during which a detected service event occurred includes thousands of metrics, many of which have multiple dimensions, thus increasing the amount of data to analyze. Prior to an analysis of metrics, such as a root cause analysis, the metrics clustering system 110 clusters and determines a representative set of metrics that are then provided to the service health analyzer 112 as a starting point for the root cause analysis. According to examples, a cluster of metrics and a representative set of metrics are determined by operations performed by the metrics clustering system 110. The metrics clustering system 110 operates to execute a number of computer readable instructions, data structures, or program modules to provide service metrics clustering to accelerate root cause analysis and mitigation of service health events. As is described in further detail below, the metrics clustering system 110 evaluates various properties of metrics in relation to different target attributes using various heuristic scoring and ranking rules. For example, the target attributes are desired/prioritized attributes of metrics, where target attributes are related to attributes of metrics of anomalous metric patterns identified as root causes of past service events of a service 108.

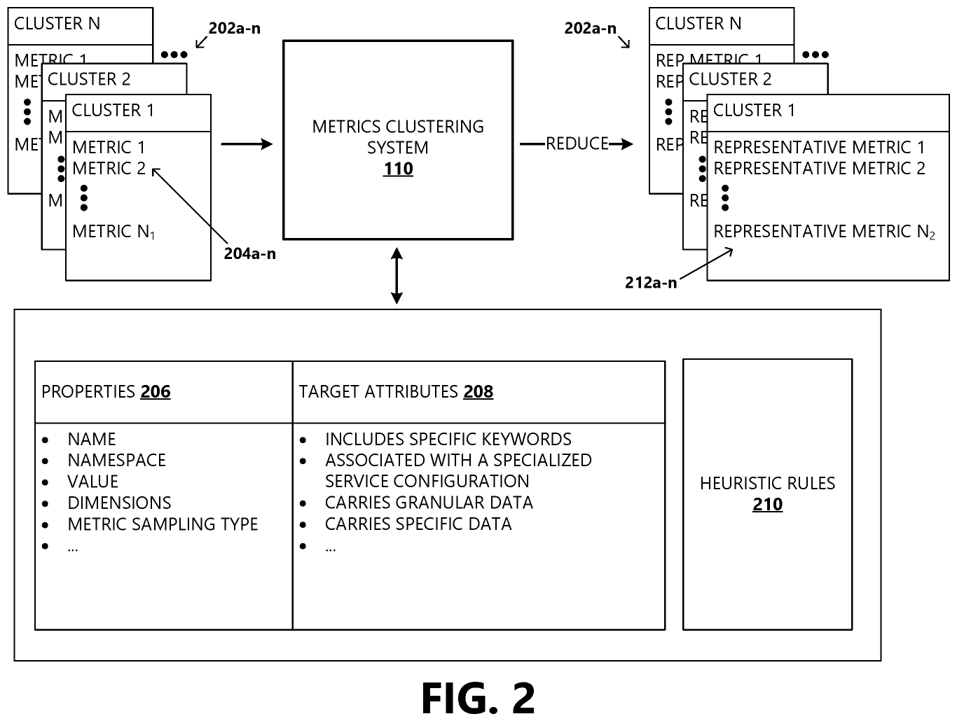

With reference now to FIG. 2, a block diagram is provided illustrating an example data flow for providing service metrics clustering. According to an example, one or more metric clusters 202a-n (collectively, clusters 202) are generated by the metrics clustering system 110, where each cluster 202 includes a plurality of metrics 204a-n (collectively, metrics 204) that are recorded within a time period during which a service event is detected to have occurred. According to an example, the metrics 204 are correlated into clusters based on a pattern of anomalous metrics identified in association with a root cause of a past service event. For instance, historical data is stored in the historical metrics data store 116 and includes metric data related to past service events. For instance, the historical data further includes anomalous metric patterns and attributes of anomalous metrics related to determined root causes of the service events. In some implementations, the target attributes 208 are determined based on an analysis of anomalous metric patterns in historical data. In some examples, the historical data is stored in association with the particular service 108 in which the service event occurred. In some implementations, the historical metrics data store 116 is included in the metrics data store 115.

The plurality of metrics 204 in a cluster 202 can include a vast number of metrics (e.g., thousands, millions, or more). According to examples, the metrics clustering system 110 reduces the dimensionality of the search space for a root cause analysis of the associated detected service event by selecting sets of representative metrics 212a-n (collectively, representative metrics 212) from the plurality of metrics 204 for the root cause analysis. For instance, a number of metrics 204 in each cluster 202 is reduced to a lesser number of representative metrics 212 that are determined to have properties 206 that are associated with one or more target attributes 208. The representative metrics 212 are determined by evaluating properties 206 of each metric 204 in a cluster 202 using various heuristic rules 210. Some example properties 206 include a namespace property, a name property, a value property, a dimensions property, and a sampling type property.

A target attribute refers to a desired/prioritized attribute of metrics. In examples, a target attribute is representative of or is associated with anomalous metric patterns identified as root causes of past service events of a service 108. An example target attribute 208 is an inclusion of particular relevant keywords (e.g., “success,” “exception,” and “failure”) in one or more properties 206 of a metric 204. For instance, inclusion of a particular keyword in a metric name, namespace, or other property 206 is an indication a metric 204 satisfies a target attribute 208 of a representative metric 212. Another example target attribute 208 is that a metric 204 is associated with a specialized service configuration (e.g., user-defined, customized, non-standard, or otherwise non-representative of a population of service configurations). An example specialized service configuration includes customer-defined metrics rather than metrics auto-generated by a machine, script, or an application programming interface (API). For instance, a length of a metric name or namespace and a frequency of occurrence of a metric name or namespace may be indicators a metric 204 is customer-defined and, thus, is likely to provide information more likely to be relevant to the root cause analysis. A further example of a target attribute 208 is that a metric 204 carries useful data. For instance, metrics having a threshold percentage of null or static values, undefined dimensions, and dimensions with too high a cardinality are indications a metric 204 has been removed by a customer or has been selected to not be reported. Thus, one or a combination of properties 206 indicate whether the metric 204 is likely to carry useful data and thus, likely to provide information relevant to the root cause analysis. For instance, a metric 204 having an undefined (e.g., null) total is indicative of a metric that is not in use and/or does not carry useful data. Yet a further example of a target attribute 208 is a metric 204 that carries granular data. According to some examples, when a metric 204 has dimensions, a more comprehensive analysis of the root cause of a service event is possible. Other example implementations include additional and/or alternative properties 206 and target attributes 208.

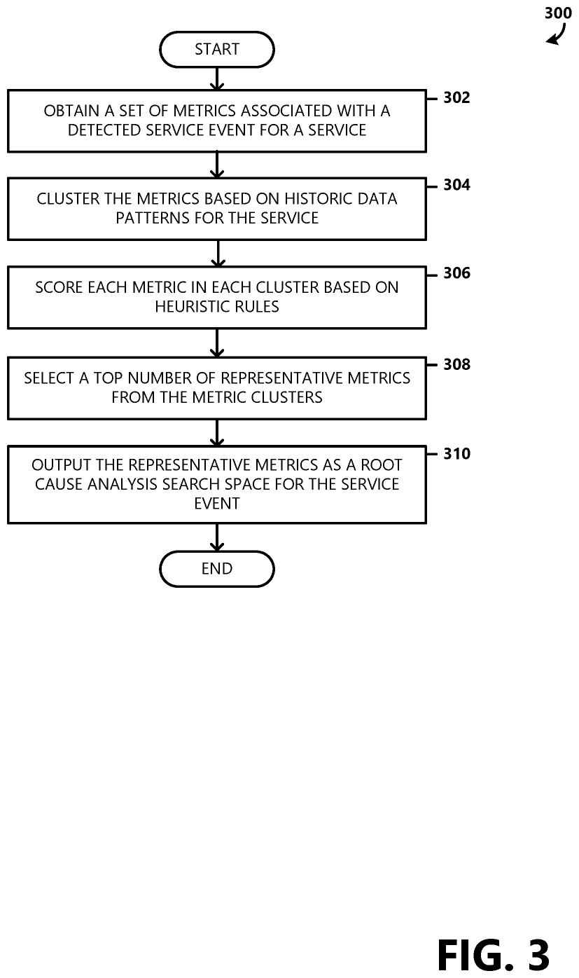

With reference now to FIG. 3, a flowchart depicting a method 300 for providing service metrics clustering according to an example is provided. The operations of method 300 may be performed by one or more computing devices, such as the metrics clustering system 110 depicted in FIG. 1. At operation 302, the metrics clustering system 110 obtains a set of metrics 204 associated with a service event, where the set of metrics includes metrics 204 recorded within a specified time period corresponding to the detected service event. For instance, the service event is associated with a performance issue, outage, or other service interruption or unavailability of a particular service 108. According to an example, the service event is detected by the metrics monitoring system 118 using one or more event detection methods. In some examples, the set of metrics includes a plurality (e.g., thousands or more) of metrics 204 associated with the detected service event. For instance, the set of metrics includes metrics 204 obtained from various metrics sources and stored in one or more metrics data stores 115, where the set of metrics 204 represent the state of the service 108 (e.g., healthy, unhealthy, degraded, in maintenance) for which the service event is detected. In some examples, the set of metrics 204 include outliers that correlate with the service event. In some examples, the metrics sources include various agents, services, and/or tools on which the service 108 depends, that are integrated in the service 108, or that are integrated in resources in the service environment 106 used by the service 108 (e.g., applications, data stores, VMs). Some example metrics sources include server transaction logs, event logs, service logs, application data, customer data, etc.

At operation 304, the metrics clustering system 110 correlates the set of metrics 204 into various metric clusters 202, where each metric cluster 202 represents a direction of focus for a root cause analysis. For example, based on an analysis of historical data, various patterns of anomalous metrics are identified as aspects of the service 108 that are associated with root causes of past service events. According to an example implementation, various combinations of metrics 204 in the set of metrics are correlated into clusters 202 based on anomalous metric patterns in the historical data for the service 108. An example of two metrics 204 that are determined to be correlated and included in the same cluster 202 is a disk writes metric and a disk write errors metric. For instance, an increase in disk writes may result in a corresponding increase in disk write errors. In some implementations, various rules are used that generalize and select metrics 204 from the set of metrics that match a historical data pattern. In some examples, a data pattern can include a chain of correlated metrics 204, where at least two metrics in the same cluster 202 are not correlated. For instance, a cluster 202 may include metrics A, B, and C, where metric A is correlated to metric B and metric B is correlated to metric C, but metric A is not correlated to metric C. In some implementations, clustering parameters are configurable, where a more restrictive configuration causes the metrics clustering system 110 to only cluster metrics 204 that are highly correlated, and a less restrictive configuration causes the metrics clustering system 110 to output fewer clusters 202, where the clusters include one or more chains of correlated metrics 204.

At operation 306, the metrics clustering system 110 uses various heuristic rules 210 to evaluate and score the metrics 204 in each cluster 202 based on various properties 206 of the metrics. In some examples, the heuristic rules 210 include rules that cause the metrics clustering system 110 to evaluate the metrics 204 based on various properties 206 of the metrics, such as a namespace property, a name property, a value property, a dimension property, and a sampling type property. For instance, the metrics clustering system 110 uses the heuristic rules 210 to generate a score for each metric 204 that is indicative of whether the metric 204 has one or more target attributes 208 of metrics of anomalous metric patterns identified as root causes of past service events of a service 108.

In some implementations, the heuristic rules 210 are created based on results of past root cause analyses of the service 108. In some examples, the heuristic rules 210 prioritize metrics 204 that include particular keywords (e.g., in the metric name). In further examples, the heuristic rules 210 prioritize metrics 204 that are determined to more likely be associated with specialized service configurations (e.g., customized, customer-generated, non-standard, not automatically or computer-generated, or otherwise non-representative of the population of service configurations). In still further examples, the heuristic rules 210 prioritize metrics 204 that are determined to carry granular data, such as prioritizing metrics that have more dimensions over metrics that have fewer dimensions. In additional examples, the heuristic rules 210 prioritize metrics 204 that carry specific data, such as metrics of a particular sampling type. Additional and/or alternative prioritizations may be used to prioritize metrics 204 based on various target attributes 208 of a root cause analysis search space. For instance, the selection and prioritization of metrics 204 is flexible, where different prioritization methods or criteria can be applied, allowing for additional or alternative approaches to determine which metrics should be given higher importance to tailor the metrics clustering system 110 to suit the specific goals and requirements of the root cause analysis.

As one example of evaluating metrics 204 based on a name property 206, the name of each metric is evaluated for detecting particular keywords, where at least a portion of the keywords are based on historical data. In some examples, historical data indicates various keywords that are associated with various anomalous metric patterns. For instance, the keywords “success,” “exception,” and “failure” may be included in a list of keywords relevant to one or more metrics corresponding to a past service event. In some examples, the metrics clustering system 110 scores each metric 204 in each metric cluster 202 based on whether the metric name includes a relevant keyword from the relevant keyword list. For instance, metrics 204 having a metric name that includes a relevant keyword are assigned a first score (e.g., 1) and metrics that do not include a relevant keyword are assigned a second score (e.g., 0). In at least one example, metric names that include a portion of a relevant keyword or a synonym for a relevant keyword are assigned a partial or reduced second score. For instance, for the keyword “failure,” the relevant keywords “failed” and “fail” and the synonymous keyword “unsuccessful” are assigned a score of 0.5. In some examples, metrics 204 that do not include a relevant keyword are removed from the metric clusters 202.

In another example of evaluating metrics 204 based on a name property 206, the metrics clustering system 110 evaluates the metric name length, where the metrics clustering system 110 scores each metric 204 in each metric cluster 202 based on a number of characters in the metric name. In some examples, a character threshold is defined. The metrics clustering system 110 evaluates each metric name against the character threshold, where metrics 204 with a metric name having a number of characters that are below the character threshold are assigned a first score (e.g., a 1) and metrics 204 with a metric name having characters above the character threshold are assigned a second score (e.g., a 0). In some examples, shorter metric names are prioritized over longer metric names such that metrics 204 with a metric name having characters above the character threshold are removed from the metric clusters 202. As an example, historical data may indicate a majority of anomalous metrics associated with past service events have metric names that include less than 25 characters. In this example, metric names that include less than 25 characters are determined to more likely be associated with a target attribute 208, such as a specialized service configuration (e.g., user-defined, customized, non-standard)). In contrast, metric names that include more than or equal to 25 characters are determined to less likely be associated with a target attribute 208, or with an attribute that is relevant to the health analysis of a service 108. In alternate implementations, the metrics clustering system 110 filters out metrics 204 that have a metric name having a number of characters below a character lower limit.

As an example of evaluating metrics 204 based on a namespace property 206, the metrics clustering system 110 evaluates the metric namespace length, where the metrics clustering system 110 scores each metric 204 in each metric cluster based on a number of characters in the metric namespace. In some implementations, the namespace is used as a logical container for organizing metrics 204. For instance, namespaces categorize or group similar metrics together. By using namespaces, groups of metrics 204 that collect different insights or performance indicators can be isolated. For example, various metrics 204 may be included in a namespace called “contoso_memory_metrics” that tracks memory-use metrics which profile a service 108. As another example, various metrics 204 may be included in a namespace called “contoso_app_transaction” that tracks metrics about customer transactions in the service 108. The metrics clustering system 110 evaluates the metric namespace of a metric 204 against a defined namespace character threshold range. In some examples, namespaces within the character threshold range are assigned a first score (e.g., a 1) and namespaces below or above the namespace character threshold range are assigned a second score (e.g., a 0). In some examples, metrics 204 with a metric namespace having characters below or above the namespace character threshold range are removed from the metric clusters 202. In such examples, metric namespaces that include fewer characters (e.g., less than 25) may be determined to be associated with an automatically-generated namespace likely to be representative of the population of service configurations.

In another example of evaluating metrics 204 based on the namespace property 206, the metrics clustering system 110 filters metrics 204 based on a number of namespaces where a metric name appears. For instance, a namespace threshold is determined based on historical data. The metrics clustering system 110 filters out metrics 204 included in more namespaces than the namespace threshold (e.g., 4 namespaces). For instance, metrics 204 that appear in multiple namespaces are determined to more likely be associated with automatically or computer-generated metrics, whereas metrics 204 that are in a fewer number of namespaces are determined to more likely be associated with customer-generated (e.g., specialized, non-standard) metrics that are intentionally included in the namespaces. Thus, in some examples, the metrics clustering system 110 prioritizes metrics 204 corresponding to customer-generated metrics. An example metric 204 that the metrics clustering system 110 may filter out for being included in more namespaces than the namespace threshold is “Heartbeat”.

As an example of evaluating metrics 204 based on a dimension property, the metrics clustering system 110 evaluates metrics 204 based on their dimensions. In some examples, the more dimensions the metric includes, the more specific or granular the data and explanation of the service event. Thus, the metrics clustering system 110 prioritizes metrics 204 with more dimensions over metrics with fewer dimensions by scoring each metric 204 in each metric cluster 202 based on a number of dimensions of the metric. In some examples, a dimension lower limit is defined. The metrics clustering system 110 evaluates each metric 204 against the dimension lower limit, where metrics 204 with a number of dimensions that satisfy the dimension lower limit are assigned a first score (e.g., a 1) and metrics 204 below the dimension lower limit are assigned a second score (e.g., a 0). In some examples, metrics 204 with a number of dimensions below the dimension lower limit are removed from the metric clusters 202.

As an example of evaluating metrics 204 based on a metric sampling type property 206, the metrics clustering system 110 evaluates the metrics 204 based on specific data carried by the metric 204. For instance, the metrics clustering system 110 assigns a score to each metric based on the metric sampling type. As an example, a metric that is a “sum” sampling type is assigned a sampling type score of 3, where the metric includes a value corresponding to the summation of all the observed metric values from all the samples and measurements during the interval. As another example, a metric that is a “count” sampling type is assigned a sampling type score of 5, where the metric includes a count value corresponding to the number of samples and measurements taken during the interval. As another example, a metric that is an “average” sampling type is assigned a sampling score of 7, where the metric includes an average value corresponding to the summation of all the observed metric values from all the samples and measurements during the interval divided by the count value corresponding to the number of samples and measurements taken during the interval. Although the above-described scoring method prioritizes aggregation, where summation values are preferred over count or average values, different scoring methods are contemplated.

As an example of evaluating metrics 204 based on a value property 206, the metrics clustering system 110 evaluates the metrics 204 based on whether the values indicate a metric 204 is likely to carry useful data. For instance, metrics 204 having a threshold percentage of null or static values, undefined dimensions, and dimensions with too high a cardinality are indications a metric 204 is less likely to be in use. For instance, the metrics clustering system 110 removes metrics 204 that include constant time series (e.g., a processor queue length metric, a check-in rate metric, a customer name). As another example, metrics 204 that include a percentage of zero values above a defined threshold are removed from the cluster(s) 202. In another example, the metrics clustering system 110 filters out metrics 204 that have undefined totals. According to an example, a metric having an undefined (e.g., null) total is indicative of a metric 204 that is not in use. For instance, a customer may have removed the metric 204 or may have elected not to report the metric 204. Additional and/or alternative attributes may be used to determine Additional and/or alternative target attributes 208.

In some examples, one or more of the scores are weighted to determine weighted scores for each heuristic rule 210. For instance, the weights may be based on a predetermined importance of each rule 210, a predetermined importance of certain metrics 204, or other factor. In some examples, additional or alternate scoring and filtering processes are performed. For instance, additional or alternate scoring and filtering processes include one or more of: uniformly sampling metrics 204 in clusters 202 using a composite score based on the metric name and maximum dimensions, and splitting totals if the name of one of the metric dimensions includes particular keywords (e.g., “code” or “type”).

At operation 308, the metrics clustering system 110 selects a target number of representative metrics 212 from each metrics cluster 202. In some examples, the target number corresponds to a maximum number of queries that can be performed within a time limit based on available computing resources. As an example, in a 30 second time limit, the metrics clustering system 110 may select 300 metrics 204. In some examples, in selecting the target number of representative metrics 212, the metrics clustering system 110 ranks the metrics 204 in each metric cluster 202 based on the above-determined scores. In examples, the ranking includes selecting a quantity (e.g., a top number or percentage of highest-ranking metrics) of each metric cluster 202 as representative metrics 212 at operation 310. For instance, the representative metrics 212 include, for the service event, salient metrics and their salient dimensions. In some examples, the number of representative metrics 212 is configurable to enable control over the size of the resulting search space.

At operation 310, the metrics clustering system 110 outputs the representative metrics as a root cause analysis search space for the service event. For example, the metrics clustering system 110 provides the representative metrics to the service health analyzer 112 for performing a root cause analysis on the representative metrics to quickly and efficiently determine the root cause of the service event. As an example, the service health analyzer 112 analyzes the representative metrics of one or more clusters and pinpoint a cause of the service event by identifying patterns or anomalies of one or a combination of the representative metrics. For instance, a spike in error rates for a specific API may indicate a bug in the code. In some examples, a root cause analysis is performed to determine a scope of a service event. For instance, by looking at metrics for different regions, it can be determined if the service event is limited to a specific region or if it is global. In further examples, additional or alternative analyses are performed.

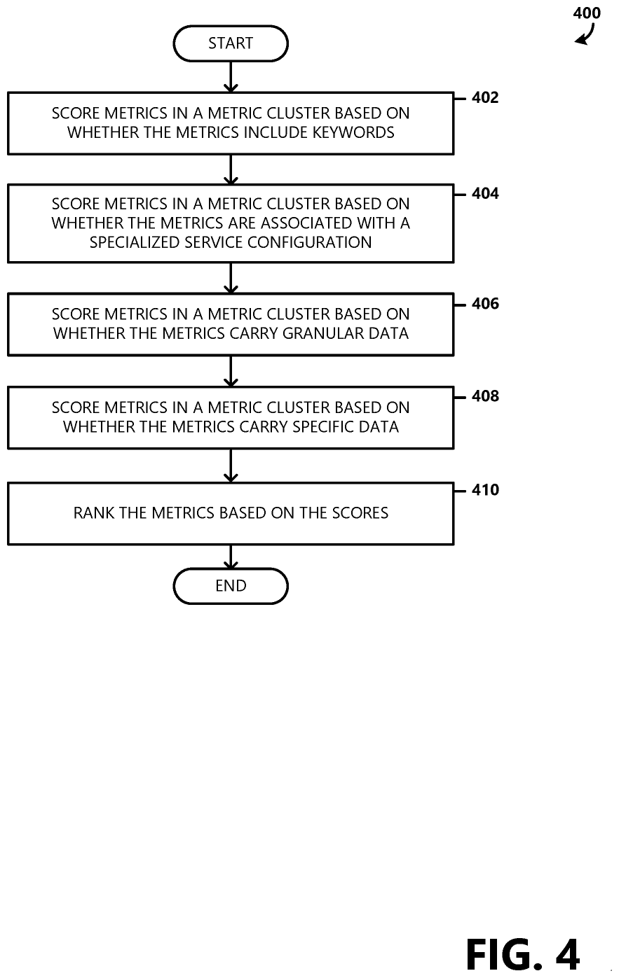

With reference now to FIG. 4, a flowchart depicting a method 400 for providing service metrics clustering according to another example is provided. The operations of method 400 may include various operations performed by the metrics clustering system 110 in association with evaluating properties 206 of a metric 204 using various heuristic rules 210 to determine whether to include the metric 204 in a set of representative metrics 212 for a root cause analysis search space.

The method 400 starts with receiving a metric cluster 202 including a plurality (e.g., thousands or more) of metrics 204 corresponding to a time period in which a service event for a service 108 was detected. According to an example, the metrics 204 are grouped into the cluster 202 based on a historic data pattern of a past root cause of an event for the service 108. At operation 402, the metrics clustering system 110 applies one or more heuristic rules 210 to score the metrics 204 based on whether the metrics 204 include specific keywords. In some examples, the metrics clustering system 110 scores each metric 204 in the metric cluster 202 based on whether the metric name and/or metric namespace includes a relevant keyword from a relevant keyword list. For instance, metrics 204 including a relevant keyword are scored higher than metrics 204 that do not include a relevant keyword. In some examples, metrics 204 having a name and/or namespace including a synonym for a relevant keyword are scored higher than metrics 204 that do not include a keyword or synonym of a keyword.

At operation 404, the metrics clustering system 110 applies one or more heuristic rules 210 to score the metrics 204 based on whether the metrics 204 are determined to be associated with a specialized service configuration rather than an automatically generated configuration, such as one generated by a machine, script, or an API. In various examples, a determination that a metric 204 has a customer-generated name and/or namespace is an indication of a specialized service configuration. For instance, the metrics clustering system 110 scores each metric 204 in the metric cluster 202 based on a number of characters in the metric name and/or metric namespace. In another example, the metrics clustering system 110 scores each metric 204 in the metric cluster 202 based on a frequency of occurrence of a metric name across namespaces. For instance, a customer-generated name or namespace is indicative that a metric 204 is likely to be useful in a root cause analysis. Thus, for instance, metrics 204 determined to satisfy a threshold number of characters are scored higher than metrics 204 that do not satisfy the threshold. Additionally, metrics 204 determined to be included in above a threshold number of namespaces are scored lower than metrics 204 that are not included in below the threshold number of namespaces. In another example, the metrics clustering system 110 scores each metric 204 in the metric cluster 202 based on whether the metric 204 has undefined dimensions. For instance, a metric 204 with defined dimensions is indicative of a specialized/non-standard service configuration, where an investment was made by the customer to instrument the metric 204 into defined dimensions and further indicative the metric 204 carries data likely to be useful in a root cause analysis. Accordingly, a metric 204 having undefined dimensions is scored lower than metrics 204 having defined dimensions.

At operation 406, the metrics clustering system 110 applies one or more heuristic rules 210 to score the metrics 204 based on whether the metrics 204 carry granular data. For instance, dimensions of a metric 204 allow for more comprehensive analysis of the root cause of a service event. Thus, the metrics clustering system 110 scores metrics 204 including dimensions higher than metrics 204 without dimensions. In some examples, a metric 204 with over a threshold number of dimensions is indicative of a metric with data not likely to be useful in the root cause analysis. Thus, the metrics clustering system 110 scores metrics 204 with a metric dimension cardinality higher than the threshold number lower than metrics 204 with a number of dimensions below the threshold number.

At operation 408, the metrics clustering system 110 applies one or more heuristic rules 210 to score the metrics 204 based on whether the metrics 204 carry specific data. In some examples, the metrics 204 are scored based on whether the metrics 204 carry a threshold percentage of null values. For instance, a metric 204 having an undefined (e.g., null) total is indicative of a metric 204 that is not in use (e.g., has been removed by a user or has been selected to not be reported). Thus, the metrics clustering system 110 scores metrics 204 including the threshold percentage of null values lower than metrics 204 that are defined. In another example, the metrics clustering system 110 scores each metric 204 in the metric cluster 202 based on whether the metric values are a constant time series. For instance, metrics 204 that have static values indicate data that is likely to not be useful in the root cause analysis, where the metrics clustering system 110 scores metrics 204 with static values lower than metrics 204 that have changing values (e.g., irregular time series). In another example, the metrics clustering system 110 scores each metric 204 in the metric cluster 202 based on a metric sampling type. For instance, the metrics clustering system 110 scores aggregation values higher than summation values, and summation values higher than count or average values. Other example implementations include additional and/or alternative properties 206 and target attributes 208.

At operation 410, the metrics clustering system 110 ranks the metrics 204 in each metric cluster 202 based on the above-determined scores. In examples, the ranking allows for selecting a top number or percentage of highest-ranking metrics of each metric cluster 202 as representative metrics 212 that include, for the service event, salient metrics and their salient dimensions.

FIG. 5 and the associated description provide a discussion of an operating environment in which examples of the disclosure may be practiced. However, the devices and systems illustrated and discussed with respect to FIG. 5 are for purposes of example and illustration, a vast number of computing device configurations that may be utilized for practicing aspects of the disclosure, described herein.

FIG. 5 is a block diagram illustrating physical components (e.g., hardware) of a computing device 500 with which examples of the present disclosure may be practiced. The computing device components described below may be suitable for one or more of the components of the system 100 described above. In a basic configuration, the computing device 500 includes a processing system 502 and a system memory 504. In some examples, the processing system 502 includes more than one processing unit or at least one processing unit is distributed to a separate computing device or to a separate component of computing device 500. Depending on the configuration and type of computing device 500, the system memory 504 may comprise volatile storage (e.g., random access memory), non-volatile storage (e.g., read-only memory), flash memory, or any combination of such memories. The system memory 504 may include an operating system 505 and one or more program modules 506 suitable for running software applications 550, the metrics clustering system 110, and other applications.

The operating system 505 may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules 506 and data files including instructions may be stored in the system memory 504. While executing on the processing system 502, the program modules 506 may perform processes including one or more of the stages of the method 300 illustrated in FIG. 3 and/or method 400 illustrated in FIG. 4.

Other program modules that may be used in accordance with examples of the present disclosure may include applications such as electronic mail and contacts applications, word processing applications, spreadsheet applications, database applications, slide presentation applications, drawing or computer-aided application programs, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing spatial-textual clustering-based predictive recognition of text in a video may be operated via application-specific logic integrated with other components of the computing device 500 on the single integrated circuit (chip). Examples of the present disclosure may also be practiced using other technologies capable of performing logical operations such as, for example, AND, OR, and NOT, including mechanical, optical, fluidic, and quantum technologies.

The computing device 500 may also have one or more input device(s) 512 such as a keyboard, a mouse, a pen, a sound input device, a touch input device, a camera, etc. Output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include RF (Radio Frequency) transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 504, the removable storage device 509, and the non-removable storage device 510 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer readable media may be part of the computing device 500. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, a computer-implemented method is described, comprising: aggregating metrics associated with a service event for a service into a metric cluster based on historical data patterns for the service; generating scores for metrics in the metric cluster based on heuristic rules for analyzing target attributes of the metrics; ranking the metrics in the metric cluster based on the scores; selecting a number of high-ranking metrics in the metric cluster as representative metrics for the metric cluster; and providing the representative metrics as a root cause analysis search space for the detected service event. In some examples, the target attributes correspond to attributes of metrics in the historical data patterns; and generating the scores comprises generating a respective score that prioritizes a subset of the metrics having a property determined to correspond to a particular target attribute of the target attributes. In further examples, generating the scores comprises generating a respective score that prioritizes a subset of the metrics with a name property that includes a number of characters below a character threshold. In yet further examples, generating the scores comprises generating a respective score that prioritizes a subset of the metrics having a name property that includes a keyword from a keywords list. In still further examples, the keyword includes at least one of the following terms: success; failure; or exception. In still yet further examples, generating the scores comprises generating a respective score that prioritizes a subset of the metrics having a name property that appears in less than a threshold number of namespaces. In some examples, generating the scores comprises generating a respective score that prioritizes a subset of the metrics having a threshold number of dimensions. In further examples, the scores prioritize a subset of the metrics based on a metric sampling type; and generating the scores further comprises: assigning a first score for a summation value metric; assigning a second score for a count value metric, where the second score is higher than the first score; and assigning a third score for an average value metric, where the third score is higher than the second score. In yet further examples, the scores prioritize a subset of the metrics that have an irregular time series. In still yet further examples, the scores prioritize a subset of the metrics that have null values that are below a threshold percentage. In yet further examples, the method further comprises receiving the metrics, wherein the metrics are recorded within a time period corresponding to the service event.

In an aspect, a system is described, comprising: a processing system; and memory storing instructions that, when executed, cause the system to: receive metrics recorded in a time period corresponding to a detected service event for a service; determine an aggregation of the metrics for a metric cluster based on a historical data pattern for the service; score the metrics in the metric cluster based on heuristic rules for analyzing target attributes of the metrics; rank the metrics in the metric cluster based on the scores; select a number of high-ranking metrics as representative metrics for the metric cluster; and provide the representative metrics as a root cause analysis search space for the detected service event. In some examples, the historical data pattern includes a subset of the metrics having a subset of target attributes; and the subset of the metrics is a determined root cause of a past service event. In further examples, the heuristic rules cause the system to prioritize the metrics having a property determined to correspond to a particular target attribute of the target attributes. In yet further examples, the property corresponds to one or more of: inclusion of a keyword; a specialized service configuration; carrying granular data; or carrying specific data. In still yet further examples, the specialized service configuration comprises one or more of: metrics with a name property including a number of characters below a threshold number of characters; metrics included in below a threshold number of namespaces; metrics having defined dimensions; and metrics having over a threshold percentage of null values. In yet further examples, the specific data includes one or more of: an irregular time series; a summation value; a count value; or an average value; and the instructions cause the system to: generate a first score for a summation value metric; generate a second score for a count value metric; and generate a third score when for an average value metric, where the second score is higher than the first score, and the third score is higher than the second score. In still yet further examples, the granular data includes defined metric dimensions. In yet further examples, the number of high-ranking metrics is configurable.

In an aspect, a computer readable medium is described comprising instructions, which when executed by a computer, cause the computer to: receive metrics recorded in a time period corresponding to a detected service event for a service; aggregate the metrics into a plurality of metric clusters based on a plurality of historical data patterns for the service; generate scores for the metrics in the plurality of metric clusters based on heuristic rules for analyzing target attributes of the metrics, where the target attributes include at least one of: inclusion of a keyword; a specialized service configuration; or granular data; rank the metrics in the plurality of metric clusters based on the scores; select a number of high-ranking metrics as representative metrics for the plurality of metric clusters; and provide the representative metrics as root cause analysis search spaces for the detected service event.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM (Erasable Programmable Read-Only Memory), NVRAM (Non-Volatile Random Access Memory), PRAM (Parameter Random Access Memory), or other such media, or networked versions of such media. Volatile media include, for example, dynamic memory such as DRAM (Dynamic Random Access Memory), SRAM (Static Random Access Memory), a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computer-implemented method, comprising:
aggregating metrics associated with a service event for a service into a metric cluster based on historical data patterns for the service;
generating scores for metrics in the metric cluster based on heuristic rules for analyzing target attributes of the metrics;
ranking the metrics in the metric cluster based on the scores;
selecting a number of high-ranking metrics in the metric cluster as representative metrics for the metric cluster; and
providing the representative metrics as a root cause analysis search space for the detected service event.

2. The method of claim 1, wherein:
the target attributes correspond to attributes of metrics in the historical data patterns; and
generating the scores comprises generating a respective score that prioritizes a subset of the metrics having a property determined to correspond to a particular target attribute of the target attributes.

3. The method of claim 1, wherein generating the scores comprises generating a respective score that prioritizes a subset of the metrics with a name property that includes a number of characters below a character threshold.

4. The method of claim 1, wherein generating the scores comprises generating a respective score that prioritizes a subset of the metrics having a name property that includes a keyword from a keywords list.

5. The method of claim 4, wherein the keyword includes at least one of the following terms:
success;
failure; or
exception.

6. The method of claim 1, wherein generating the scores comprises generating a respective score that prioritizes a subset of the metrics having a name property that appears in less than a threshold number of namespaces.

7. The method of claim 1, wherein generating the scores comprises generating a respective score that prioritizes a subset of the metrics having a threshold number of dimensions.

8. The method of claim 1, wherein:
the scores prioritizes a subset of the metrics based on a metric sampling type; and
generating the scores further comprises:
assigning a first score for a summation value metric;
assigning a second score for a count value metric, where the second score is higher than the first score; and
assigning a third score for an average value metric, where the third score is higher than the second score.

9. The method of claim 1, wherein the scores prioritize a subset of the metrics that have an irregular time series.

10. The method of claim 1, wherein the scores prioritize a subset of the metrics that have null values that are below a threshold percentage.

11. The method of claim 1, further comprising receiving the metrics, wherein the metrics are recorded within a time period corresponding to the service event.

12. A system, comprising:
a processing system; and
memory storing instructions that, when executed, cause the system to:
receive metrics recorded in a time period corresponding to a detected service event for a service;
determine an aggregation of the metrics for a metric cluster based on a historical data pattern for the service;
score the metrics in the metric cluster based on heuristic rules for analyzing target attributes of the metrics;
rank the metrics in the metric cluster based on the scores;
select a number of high-ranking metrics as representative metrics for the metric cluster; and
provide the representative metrics as a root cause analysis search space for the detected service event.

13. The system of claim 12, wherein:
the historical data pattern includes a subset of the metrics having a subset of target attributes; and
the subset of the metrics is a determined root cause of a past service event.

14. The system of claim 12, wherein the heuristic rules cause the system to prioritize the metrics having a property determined to correspond to a particular target attribute of the target attributes.

15. The system of claim 14, wherein the property corresponds to one or more of:
inclusion of a keyword;
a specialized service configuration;
carrying granular data; or
carrying specific data.

16. The system of claim 15, wherein the specialized service configuration comprises one or more of:
metrics with a name property including a number of characters below a threshold number of characters;
metrics included in below a threshold number of namespaces;
metrics having defined dimensions; and
metrics having over a threshold percentage of null values.

17. The system of claim 15, wherein:
the specific data includes one or more of:
an irregular time series;
a summation value;
a count value; or
an average value; and
the instructions cause the system to:
generate a first score for a summation value metric;
generate a second score for a count value metric; and
generate a third score when for an average value metric, where the second score is higher than the first score, and the third score is higher than the second score.

18. The system of claim 15, wherein the granular data includes defined metric dimensions.

19. The system of claim 12, wherein the number of high-ranking metrics is configurable.

20. A computer readable medium comprising instructions, which when executed by a computer, cause the computer to:
receive metrics recorded in a time period corresponding to a detected service event for a service;
aggregate the metrics into a plurality of metric clusters based on a plurality of historical data patterns for the service;
generate scores for the metrics in the plurality of metric clusters based on heuristic rules for analyzing target attributes of the metrics, where the target attributes include at least one of:
inclusion of a keyword;
a specialized service configuration; or
granular data;
rank the metrics in the plurality of metric clusters based on the scores;
select a number of high-ranking metrics as representative metrics for the plurality of metric clusters; and
provide the representative metrics as root cause analysis search spaces for the detected service event.
